(19) United States
(12) Patent Application Publication
(10) Pub. No.: US 2021/0349990 A1
(43) Pub. Date: Nov. 11, 2021

(54) COUNTERMEASURE FOR PROTECTING AGAINST A FAULT INJECTION ATTACK IN A DATA PROCESSING SYSTEM

(71) Applicant: NXP B.V., Eindhoven (NL)

(72) Inventors: Rob COSARO, San Jose, CA (US); Miroslav Knezevic, Austin, TX (US); Durgesh Pattamatta, Camas, WA (US)

(21) Appl. No.: 16/868,594

(22) Filed: May 7, 2020

(51) Int. Cl. G06F 21/52; G06F 9/48; G06F 21/56

(52) U.S. Cl. CPC G06F 21/52; G06F 2221/033; G06F 21/566; G06F 9/4881

(57) ABSTRACT

A method is provided for protecting execution of a program against a fault injection attack. In one embodiment, a portion of the program includes multiple substantially logically identical conditional operations that are executed in a sequence. An attacker must successfully inject a fault at each instance of the conditional operations to cause the program execution to reach the final state. The multiple conditional operations may ask the same question differently so that the glitch will not cause the same response from both conditional operations. Also, the program portion may make advancement from one state to the next contingent on arriving at the next state from a valid previous state. The described program portions with multiple instances of a conditional operation make a program execution more resistant to a glitch type of fault injection attack.

### BACKGROUND

### Field

This disclosure relates generally to data processing, and more particularly, to a countermeasure for protecting against a fault injection attack in a data processing system.

### Related Art

Some fault injection attacks are non-invasive attempts to inject a “glitch” into a device in order to change program execution in the device. A glitch may be a power supply or other voltage glitch, a clock glitch, electromagnetic fault injection (EMFI), or the like. The attacker may attempt to inject the glitch at a particular point in program execution to cause the program execution to take a wrong branch, to skip a step of the program, or some other wrong decision. The glitch attack may allow an attacker to skip a mathematically complex cryptographical operation such as a signature verification during a secure booting process, and thus execute unauthorized code or gain access to a secure data processing system.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a state diagram for a known conditional state transition.

FIG. 2 illustrates a state diagram for a program portion resistant to a fault injection attack in accordance with an embodiment.

FIG. 3 illustrates a state diagram for a program portion resistant to a fault injection attack in accordance with another embodiment.

FIG. 4 illustrates a state diagram for a program portion resistant to a fault injection attack in accordance with another embodiment.

FIG. 5 illustrates a data processing system suitable for implementing the embodiments of FIG. 1 to FIG. 4.

### DETAILED DESCRIPTION

Generally, there is provided, a method for protecting execution of a program against a fault injection attack. The method includes executing multiple instances of a conditional branch operation multiple times in a sequence. For example, the conditional branch operation may be an if-then-else statement. As an example, an if-then-else conditional operation may ask the question: does A=B? If the answer is yes, in one implementation, program execution proceeds to the next state, else program execution returns to a previous state. In one example, the if-then-else conditional branch is implemented twice in sequence, where the condition is identical in both conditional operations. If an attacker causes a glitch to happen at the first instance of the conditional branch and successfully causes the conditional branch to be skipped, the program execution proceeds to the second instance of the if-then-else conditional branch and the attacker must inject a glitch at the correct time that also causes the program execution to skip the second instance and proceed to the next state. The likelihood that an attacker will be successful twice in succession is very low because two separate glitches may not affect the two decisions the same way. Alternatively, the conditional statement may be logically the same, but the implementation of the conditional statement may be different. The different implementation may behave differently if the same glitch is injected twice. In addition, for additional resistance to a fault injection attack, another embodiment determines if a current state was reached from a valid previous state. The valid previous state may be stored in an assigned register bit field. In a further embodiment, the same conditional operation in a subsequent program execution may be executed a final time where a correct decision allows program execution to remain in a final state, and a wrong decision requires the program execution to return to a previous state. In one embodiment, the previous state is the initial state. This may prevent an attacker from doing too much damage in the event the attacker is successful bypassing the previous conditional operation. Depending on the sensitivity of the data to be protected, and on the sophistication of the attacker to be protected against, more intermediate conditional operations and states can be added to the program.

In accordance with an embodiment, there is provided, a method for protecting execution of a program against a fault injection attack in a data processing system, the method including: executing a first conditional operation while the program execution is in a first state, wherein when an evaluation of a condition of the first conditional operation is true, the program execution proceeds forward from the first state to a second state, and wherein when an evaluation of the first conditional operation is false, program execution remains at the first state; and executing a second conditional operation while the program execution is in the second state, wherein a condition of the second conditional operation is substantially the same as the condition of the first conditional operation, wherein when an evaluation of the condition of the second conditional operation is true, the program execution proceeds forward from the second state to a third state, and wherein when an evaluation of the condition of the second conditional operation is false, program execution returns to the first state. The method may further include checking that the program execution arrived in each of the first, second, and third states from an allowed previous state, wherein if the program execution is determined to have arrived at the third state from an allowed previous state, the program execution can remain in the third state, and if the program execution is determined to have arrived at the third state from an unallowed state, the program execution returns to the first state. The allowed previous state may be stored in a register bit field and wherein checking that program execution arrival in the third state is from the allowed previous state further comprises checking the register bit field for the allowed previous state. The register bit field may store a program counter value for the allowed previous state. The method may further include executing a third conditional operation from the third state, wherein a condition of the third conditional operation is identical to the condition of both the first and second conditional operations, wherein when an evaluation of a condition of the third conditional operation is true, the program execution stays in the third state, and wherein when an evaluation of the condition of the third conditional operation is false, program execution goes back from the third state to the first state. The method may be implemented as instructions stored on a non-transitory machine-readable storage medium. The first and second conditional operations may be logically identical if-then-else operations having different implementations. The method may further include: performing the steps of executing using a first state machine in the data processing system; performing the steps of executing using a second state machine in the data processing system; and determining that the first and second state machines both reach the third state via the second state. The first state machine may be a software state machine and the second state machine may be a secure hardware state machine. The method may further include executing a third conditional operation from the third state in both the first and second state machines, wherein when a condition of the third conditional operation is true, the program execution stays in the third state, and wherein when the condition of the third conditional operation is false, program execution goes returns to the first state.

In another embodiment, there is provided, a method for protecting execution of a program against a fault injection attack in a data processing system, the method including: executing a first conditional operation while the program execution is in a first state, wherein when a condition of the first conditional operation is true, the program execution proceeds forward from the first state to a second state, and when the condition of the first conditional operation is false, program execution remains at the first state; executing a second conditional operation while the program execution is in the second state, wherein a condition of the second conditional operation is substantially the same as the condition of the first conditional operation, wherein when the condition of the second conditional operation is true, the program execution proceeds forward from the second state to a third state, and when the condition of the second conditional operation is false, program execution returns to the first state; and executing a third conditional operation while the program execution is in the third state, wherein a condition of the third conditional operation is substantially the same as the condition of the first and second conditional operations, wherein when the condition of the third conditional operation is true, the program execution stays in the third state, and when the condition of the third conditional operation is false, the program execution returns to the first state. The method may further include checking that the program execution arrived in each of the first, second, and third states from an allowed previous state, wherein if the program execution is determined to have arrived at the third state from an allowed previous state, the program execution remains in the third state, and if the program execution is determined to have arrived at the third state from an unallowed state, the program execution returns to the first state. The allowed previous state may be stored in a register bit field of the data processing system and wherein checking that program execution arrival in the third state is from the allowed previous state may further include checking the register bit field for the allowed previous state. The register bit field may store a program counter value for the allowed previous state. The first, second, and third conditional operations may be executed in a sequence. The first, second, and third conditional operations may be logically identical if-then-else operations and at least one of the first, second, and third conditional operations is implemented differently from the other two. The method may further include: performing the steps of executing by a first state machine in the data processing system; performing the steps of executing by a second state machine in the data processing system; and determining that the first and second state machines both reach the third state via second state. Performing the steps of executing by the first state machine may further include performing the steps with a software state machine, and wherein performing the steps of executing of the second state machine may further include performing the steps with a secure hardware state machine. The steps of performing and determining may be executed in parallel by the first and second state machines. The method may be implemented as instructions stored on a non-transitory machine-readable storage medium.

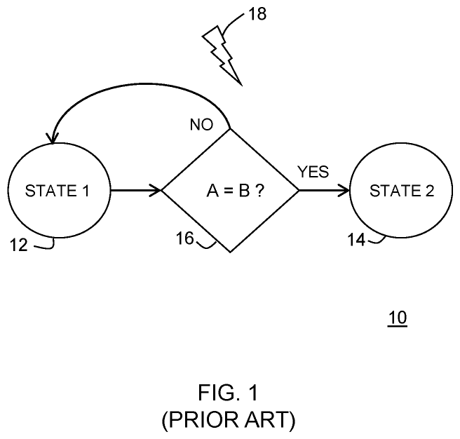

FIG. 1 illustrates state diagram for a known conditional state transition 10.

Conditional state transition 10 is a transition from a first state (STATE 1) 12 to a second state (STATE 2) 14 conditioned on the outcome of a conditional operation 16 (shown as a decision block). As an example, conditional operation 16 requires a decision between two paths conditioned with the comparison of two values A and B. If A equals B, program execution proceeds as indicated by the YES path from STATE 1 to STATE 2. However, if A does not equal B, program execution does not proceed and remains at STATE 1 as indicated by the NO path. Hardware logic or software code can be used to implement the functionality of conditional operation 16. Conditional operations like conditional operation 16 are frequently targeted in a glitch attack as indicated by glitch 18. A goal of the attack may be to cause program execution to proceed from STATE 1 to STATE 2 even when, for example, A does not equal B, thus potentially skipping the need to correctly perform a complex security protocol, such as a signature verification, to execute unauthorized code or gain access to a device. This may be accomplished by the attacker using a single well-timed momentary glitch 18.

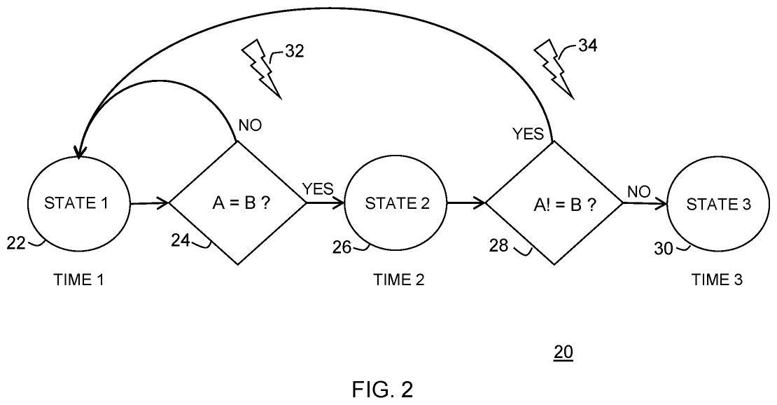

FIG. 2 illustrates a state diagram for a program portion 20 in accordance with an embodiment. The program portion may be a critical signature verification portion of a mathematically complex cryptographic protocol. The state diagram includes states 22, 26, and 30 and conditional operations 24 and 28. Conditional operations 24 and 28 each include the same conditional if-then-else statement except that the implementation may be different. For example, conditional operation 24 is implemented as A=B and a conditional logically equivalent operation 28 is implemented as A!=B. Progression through the states 22, 26, and 30 is sequential where state 22 (STATE 1) may be entered from a preceding state (not shown) at a TIME 1 and progresses to state 30 (STATE 3) at TIME 3 via an intermediate state 26 (STATE 2) at TIME 2. Arrival at state 26 is conditioned on an evaluation of A=B at decision 24 being true. Likewise, arrival at state 30 is conditioned on the evaluation of A!=B at decision 28 being false. These conditions are logically equivalent with different physical implementations. If either decision step 24 or 28 determines that A is not equal to B, then the program execution returns to state 22 (STATE 1) and progress to state 30 starts over.

Program execution according to the embodiment of FIG. 2 requires the data processing system to ask the same question twice and requires the actual comparison of A and B to occur twice. Other examples of if-then-else statements includes if A>B, if A>=B, if A<B, if A<=B, if A is even, if A is odd, if A is in a range (A1, A2), etc. To defeat the embodiment of FIG. 2, an attacker may attempt to inject two glitches, such as glitches 32 and 34 at the times when each of the decisions are made. However, the same glitch may not affect the two conditional operations 24 and 28 the same way. Also, the two conditional operations 24 and 28 may be implemented differently from each other but with the same result. That is, the functionality of conditional operation 24 may be implemented to ask the question: if A equals B, then go to state 26 (STATE 2), else stay in state 22 (STATE 1). The functionality of conditional operation 28 may be implemented to ask the question differently: if A is not equal to B, then go back to state 22 (STATE 1), else go to state 30 (STATE 3). Implementing the two conditional operations 24 and 28 this way should cause the two glitches 32 and 34, if directed separately to the two conditions, to affect the two conditions in different ways. This will lessen the likelihood of a successful attack. Note that in other embodiments, the conditional operations 24 and 28 may be repeated any number of times.

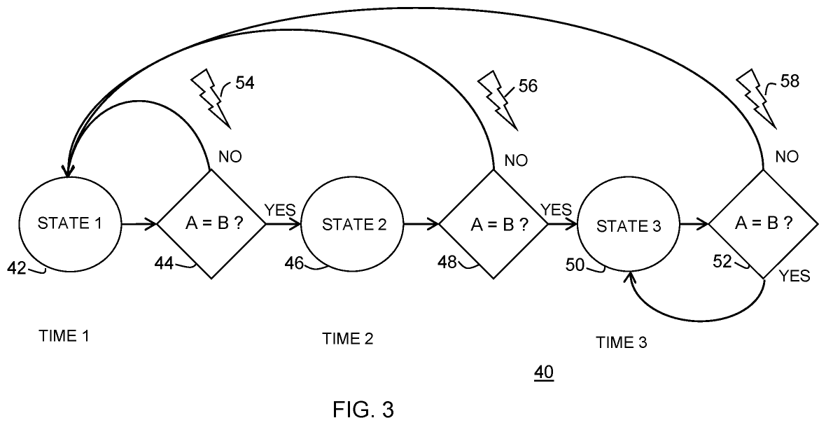

FIG. 3 illustrates a state diagram for a program portion 40 in accordance with another embodiment. The state diagram of FIG. 3 includes states 42, 46, and 50, and conditional operations 44, 48, and 52. Conditional operations 44, 48, and 52 each include the same conditional if-then-else statement. Alternatively, one or more of the conditional operations of FIG. 3 may be logically equivalent but implemented differently as illustrated in FIG. 2. Progression through the states 42, 46, and 50 is the same as described above for FIG. 2. State 42 (STATE 1) is entered from a preceding state (not shown) at TIME 1 and progresses to state 50 (STATE 3) at TIME 3 via intermediate state 46 (STATE 2) at TIME 2. In addition, FIG. 3 includes conditional operation 52 at state 50. Conditional operation 52 includes the same condition as conditional operations 44 and 48. At conditional operation 52, if A equals B, program execution can remain at state 50 (STATE 3). However, if A is not equal to B, the program execution transitions back to state 42 (STATE 1). The advantage of questioning the final state 50 (STATE 3) is that even if the attacker has managed to glitch the program with two glitches 54 and 56 and proceeded through the correct path to state 50, the attacker will have to successfully glitch conditional operation 53 with glitch 58 to remain at state 50. Otherwise, the program returns to the state in which it was supposed to be (STATE 1).

Also, as the program progresses through states 42, 46, and 50, the program may check at each state if arrival at the current state is from an allowed previous state. To do this, the previous state location, such as a program counter value, is stored in a register bit-field. If a check of the register bit-field during program execution indicates that a transition was not valid, then an exception may be raised, and program execution returns to the initial state (STATE 1).

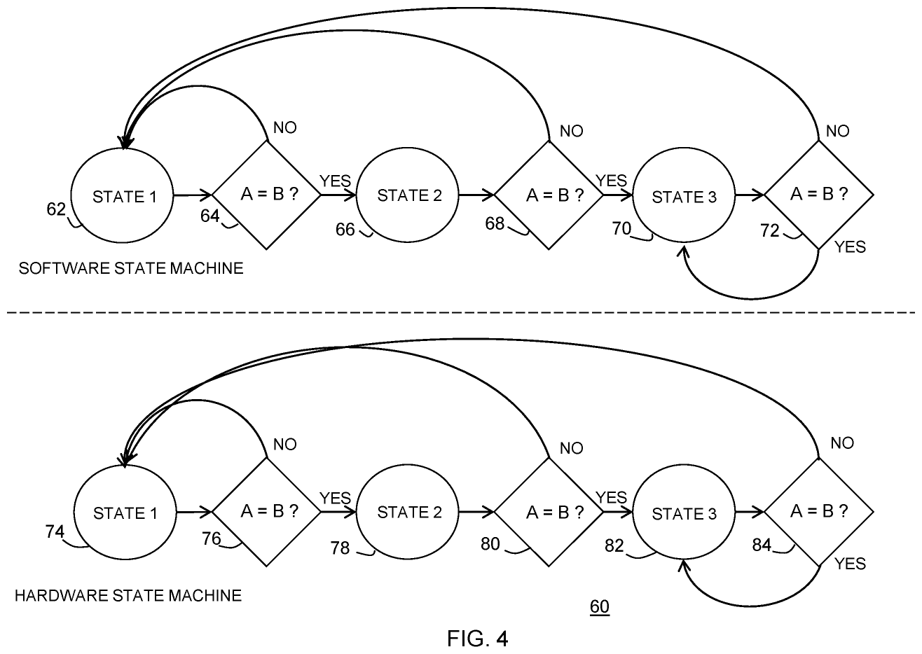

FIG. 4 illustrates a state diagram for a program portion 60 resistant to a fault injection attack in accordance with another embodiment. In FIG. 4, the program portion 60 is implemented twice: in a software state machine and a hardware state machine. One of the state machines may be implemented in a secure environment. The software portion is implemented in the software state machine with states 62, 66, and 70 and conditional operations 64, 68, and 72. The program portion is also implemented in the hardware state machine with states 74, 78, and 80, and conditional operations 76, 80, and 84. The program portion 60 as implemented in the software state machine and hardware state machine are substantially the same and both operate as described above in the description of FIG. 3. Note, as discussed above, the logical operations illustrated in FIG. 4 are the same, but in both the software state machine and the hardware state machine, the physical implementations of one or more of the logical operations may be different. At the predetermined states, for example, STATE 3, both paths compare results to verify that the same result was reached. If not, then an exception may be raised. By implementing a critical portion of the program as shown in FIG. 4, it is even more difficult for an attacker to influence the program execution to reach the required result. The software state machine and the hardware state machine may execute the program portion in parallel, or concurrently.

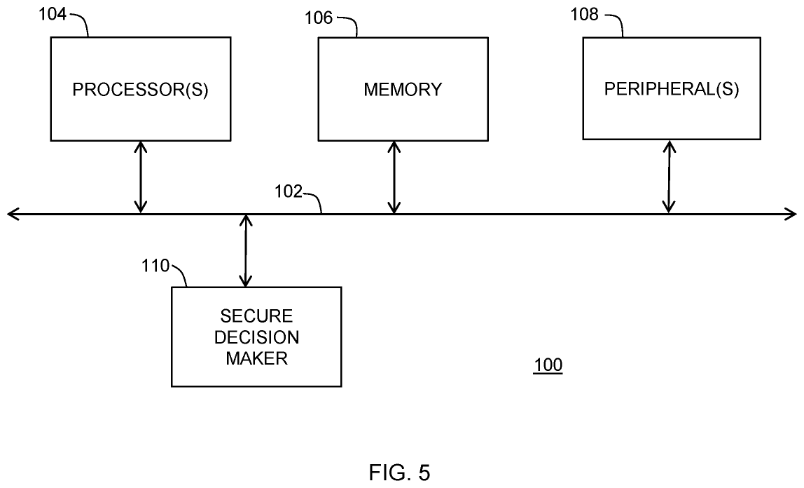

FIG. 5 illustrates a data processing system 100 suitable for implementing the embodiments of FIG. 1 to FIG. 4. Data processing system 100 may be implemented on one or more integrated circuits and may be used in an implementation of the described embodiments. Data processing system 100 includes bus 102. Connected to bus 102 is one or more processors 104, memory 106, peripheral(s) 108, and secure decision maker 110. The one or more processors 104 may include any hardware device capable of executing instructions stored in memory 106. For example, processor(s) 104 may execute the program portions described in FIG. 1-FIG. 4. Processor(s) 104 may be, for example, a microprocessor, field programmable gate array (FPGA), application-specific integrated circuit (ASIC), or similar device. Processor 104 may include one or more processor cores. Processor(s) 104 may be implemented in a secure hardware element and may be tamper resistant.

Memory 106 may include multiple and different types of memory. Memory 106 may include a data memory and instruction memory. Memory 106 may be any kind of memory, such as for example, L1, L2, or L3 cache or system memory. Memory 106 may include volatile memory such as static random-access memory (SRAM) or dynamic RAM (DRAM), or may include non-volatile memory such as flash memory, read only memory (ROM), or other volatile or non-volatile memory. Also, at least a portion of memory 106 may be implemented in a secure hardware element. Alternately, memory 106 may be a hard drive implemented externally to data processing system 100. In one embodiment, memory 106 is used to store the program portions illustrated in FIG. 1-FIG. 4. Also, memory 106 may include register files and may include a bit-field for storing the valid previous state of a state transition in accordance with the above described embodiment. Memory 106 may include one or more machine-readable storage media for storing instructions and/or for execution by processor(s) 104.

Peripheral(s) 108 may include one or more of any type of peripheral. A peripheral is an internal or external module or device that adds functionality to data processing system 100. The number and type of peripherals depends on the intended application of data processing system 100. Example peripherals include but are not limited to: direct memory access (DMA) module, analog-to-digital converter (ADC), digital-to-analog converter (DAC), controller area network (CAN) module, universal asynchronous receiver-transmitter (UART)), serial peripheral interface (SPI), etc.

Secure decision maker 110 may be implemented in a trusted execution environment or other secure element and may be used to implement the hardware state machine program portion illustrated in FIG. 4, while processor 104 is used to execute the software state machine program portion illustrated in FIG. 4. Also, secure decision maker 110 can be used to implement the functionality described in FIG. 2 and FIG. 3 and inform processors 104 about its decision.

Various embodiments, or portions of the embodiments, may be implemented in hardware or as instructions on a non-transitory machine-readable storage medium including any mechanism for storing information in a form readable by a machine, such as a personal computer, laptop computer, file server, smart phone, or other computing device. The non-transitory machine-readable storage medium may include volatile and non-volatile memories such as read only memory (ROM), random access memory (RAM), magnetic disk storage media, optical storage medium, flash memory, and the like. The non-transitory machine-readable storage medium excludes transitory signals.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for protecting execution of a program against a fault injection attack in a data processing system, the method comprising:
executing a first conditional operation while the program execution is in a first state, wherein when an evaluation of a condition of the first conditional operation is true, the program execution proceeds forward from the first state to a second state, and wherein when an evaluation of the first conditional operation is false, program execution remains at the first state; and
executing a second conditional operation while the program execution is in the second state, wherein a condition of the second conditional operation is substantially the same as the condition of the first conditional operation, wherein when an evaluation of the condition of the second conditional operation is true, the program execution proceeds forward from the second state to a third state, and wherein when an evaluation of the condition of the second conditional operation is false, program execution returns to the first state.

2. The method of claim 1, further comprising checking that the program execution arrived in each of the first, second, and third states from an allowed previous state, wherein if the program execution is determined to have arrived at the third state from an allowed previous state, the program execution can remain in the third state, and if the program execution is determined to have arrived at the third state from an unallowed state, the program execution returns to the first state.

3. The method of claim 2, wherein the allowed previous state is stored in a register bit field and wherein checking that program execution arrival in the third state is from the allowed previous state further comprises checking the register bit field for the allowed previous state.

4. The method of claim 3, wherein the register bit field stores a program counter value for the allowed previous state.

5. The method of claim 1, further comprising executing a third conditional operation from the third state, wherein a condition of the third conditional operation is identical to the condition of both the first and second conditional operations, wherein when an evaluation of a condition of the third conditional operation is true, the program execution stays in the third state, and wherein when an evaluation of the condition of the third conditional operation is false, program execution goes back from the third state to the first state.

6. The method of claim 1, wherein the method is implemented as instructions stored on a non-transitory machine-readable storage medium.

7. The method of claim 1, wherein the first and second conditional operations are logically identical if-then-else operations having different implementations.

8. The method of claim 1, further comprising:
performing the steps of executing using a first state machine in the data processing system;
performing the steps of executing using a second state machine in the data processing system; and
determining that the first and second state machines both reach the third state via the second state.

9. The method of claim 8, wherein the first state machine is a software state machine and the second state machine is a secure hardware state machine.

10. The method of claim 8, further comprising executing a third conditional operation from the third state in both the first and second state machines, wherein when a condition of the third conditional operation is true, the program execution stays in the third state, and wherein when the condition of the third conditional operation is false, program execution goes returns to the first state.

11. A method for protecting execution of a program against a fault injection attack in a data processing system, the method comprising:
executing a first conditional operation while the program execution is in a first state, wherein when a condition of the first conditional operation is true, the program execution proceeds forward from the first state to a second state, and when the condition of the first conditional operation is false, program execution remains at the first state;
executing a second conditional operation while the program execution is in the second state, wherein a condition of the second conditional operation is substantially the same as the condition of the first conditional operation, wherein when the condition of the second conditional operation is true, the program execution proceeds forward from the second state to a third state, and when the condition of the second conditional operation is false, program execution returns to the first state; and
executing a third conditional operation while the program execution is in the third state, wherein a condition of the third conditional operation is substantially the same as the condition of the first and second conditional operations, wherein when the condition of the third conditional operation is true, the program execution stays in the third state, and when the condition of the third conditional operation is false, the program execution returns to the first state.

12. The method of claim 11, further comprising checking that the program execution arrived in each of the first, second, and third states from an allowed previous state, wherein if the program execution is determined to have arrived at the third state from an allowed previous state, the program execution remains in the third state, and if the program execution is determined to have arrived at the third state from an unallowed state, the program execution returns to the first state.

13. The method of claim 12, wherein the allowed previous state is stored in a register bit field of the data processing system and wherein checking that program execution arrival in the third state is from the allowed previous state further comprises checking the register bit field for the allowed previous state.

14. The method of claim 13, wherein the register bit field stores a program counter value for the allowed previous state.

15. The method of claim 11, wherein the first, second, and third conditional operations are executed in a sequence.

16. The method of claim 11, wherein the first, second, and third conditional operations are logically identical if-then-else operations and at least one of the first, second, and third conditional operations is implemented differently from the other two.

17. The method of claim 11, further comprising:
performing the steps of executing by a first state machine in the data processing system;
performing the steps of executing by a second state machine in the data processing system; and
determining that the first and second state machines both reach the third state via second state.

18. The method of claim 17, wherein performing the steps of executing by the first state machine further comprises performing the steps with a software state machine, and wherein performing the steps of executing of the second state machine further comprises performing the steps with a secure hardware state machine.

19. The method of claim 17, wherein the steps of performing and determining are executed in parallel by the first and second state machines.

20. The method of claim 11, wherein the method is implemented as instructions stored on a non-transitory machine-readable storage medium.
